(19) United States
(12) Patent Application Publication
(10) Pub. No.: US 2023/0313731 A1
(43) Pub. Date: Oct. 5, 2023

(54) Anti-Tampering Device for a Degassing Tank Cap

(71) Applicant: Illinois Tool Works Inc., Glenview, IL (US)

(72) Inventors: Serge IAFRATE, Montmerle sur Saône (FR); Arnaud MONTUS, Sain Bel (FR)

(21) Appl. No.: 18/130,188

(22) Filed: Apr. 3, 2023

(30) Foreign Application Priority Data
Apr. 4, 2022 (FR) 2203029
Apr. 8, 2022 (FR) 2203226
Aug. 16, 2022 (FR) 2208325
Feb. 3, 2023 (FR) 2301045
Mar. 31, 2023 (FR) 2303192

(51) Int. Cl. F01P 11/02; B65D 55/02

(52) U.S. Cl. CPC F01P 11/0247; B65D 55/024

(57) ABSTRACT

The disclosure relates to an anti-tampering device (100, 200, 300, 400, 500) for securing a cap (103, 203, 303, 403, 503) onto a neck of a degassing tank of a vehicle cooling circuit, wherein the device comprises locking means that are either attached to a shell configured to surround and/or secure the cap on the neck (104, 204, 304), or attached to the cap and the neck (404, 504) of the tank. The device may comprise tamper-evident means (227′, 306) to provide evidence of unlocking the locking means. Additionally or alternatively, the device may be configured to be removed only by destruction such that once removed, it can no longer be reused.

### RELATED APPLICATIONS

The present application claims the benefit of French Patent Application No. 2203029, filed Apr. 4, 2022; U.S. Pat. No. 2,203,226, filed Apr. 8, 2022; U.S. Pat. No. 2,208,325, filed Aug. 16, 2022; U.S. Pat. No. 2,301,045, filed Feb. 3, 2023; and U.S. Pat. No. 2,303,192, filed Mar. 31, 2023, the contents of which are hereby incorporated by reference.

### TECHNICAL FIELD

The present disclosure generally relates to cooling circuits of vehicles and more particularly of electric or hybrid motor vehicles. In particular, the present disclosure relates to the cooling circuits of such electric or hybrid vehicles.

### TECHNICAL BACKGROUND

As a result of the economic constraints caused by the increase in fuel prices and the environmental constraints in connection with the regulation of polluting emissions and greenhouse gases, we are seeing the development of electric vehicles and hybrid vehicles, in other words, vehicles that use a combustion engine and an electric engine.

Electric or hybrid vehicles use powerful batteries that need to be cooled. Such cooling can be obtained in particular by means of a cooling circuit comprising a heat transfer circuit circulating a coolant (or heat transfer fluid) around the battery or batteries and/or around the cells of the battery or batteries.

Such a cooling circuit comprises a degassing tank, also known as an expansion tank, delimiting an internal volume for receiving a coolant to be degassed. Thus, such a degassing tank is intended to receive the coolant, particularly for any adjustment of the coolant level in the tank. Therefore, when servicing the vehicle, it may be necessary to add coolant to the degassing tank. Accordingly, such a tank comprises a cap that can be removed, for example when servicing the vehicle.

The cooling circuit might also have a coolant leak, for example. Such a leak can cause a vehicle fire if the fluid comes into contact with the battery. To counteract such a leak, an unskilled user (for example, the vehicle owner) might react by adding coolant to the tank and thereby masking the leak.

Moreover, when topping off the coolant, an unskilled user reaching in to remove the cap might touch the battery or batteries and/or their cells, which can be very dangerous for the operator.

### SUMMARY

According to at least one of its embodiments, the present disclosure aims to provide a solution that deters an unskilled user from attempting to top off the coolant or adjust the coolant level. According to at least one of its embodiments, the present disclosure also aims to limit the risks of a coolant leak being masked by an unskilled user. According to at least one of its embodiments, the present disclosure also aims to reduce battery-related risks for unskilled users.

The present disclosure relates to an anti-tampering device or means for a degassing tank cap of a vehicle cooling circuit, which is configured to surround and/or secure the cap to a neck of the tank.

The disclosure thus provides a means to prevent an unskilled user from opening the degassing tank cap.

The anti-tampering means or device may be for securing a cap onto a neck of a degassing tank of a vehicle cooling circuit. The means or device may comprise locking means. The locking means may be attached to a shell configured to surround and lock the cap onto the neck. The locking means may be attached to the cap and/or the neck of the tank.

The present disclosure also relates to an anti-tampering device for securing a cap onto a neck of a degassing tank of a vehicle cooling circuit, wherein the device comprises locking means that are either attached to a shell configured to surround and/or secure the cap on the neck, or attached to the cap and the neck of the tank.

The present disclosure also relates to an anti-tampering device for securing a cap onto a neck of a degassing tank of a vehicle cooling circuit, wherein the device comprises locking means that are attached to a shell configured to surround and/or secure the cap on the neck.

The shell may be configured to prevent the removal of the cap from the neck.

The shell may be configured to prevent the cap from being unscrewed from the neck.

The means or device or shell may comprise a first portion and a second portion. The first portion and the second portion may be adapted to form a shell around the cap and/or a neck of the tank.

The present disclosure also relates to an anti-tampering device for a degassing tank cap of a vehicle cooling circuit, wherein it comprises a first portion and a second portion adapted to form a shell around the cap and/or a neck of the tank.

Thus, for example, the anti-tampering device comprises a protective shell that can be closed around the cap and/or the neck of the degassing tank.

According to one aspect of the disclosure, the first portion and the second portion may each comprise cooperating parts of the locking means. The anti-tampering device or the shell comprises means for locking the first portion and second portion around the cap and/or the neck of the tank.

Thus, for example, once the first portion and second portion of the device are locked around the cap and/or neck of the degassing tank, it is difficult for an unskilled user, for example the vehicle owner, to top off the coolant in the degassing tank himself. Thus, the unskilled (or non-professional) user is deterred by the disclosure from doing anything on the cooling circuit himself in contact with the battery or batteries or with the battery cells. This has the advantage of reducing the risk of masking coolant leaks.

The locking means may be irreversible and/or non-unlockable. The device may be configured to be removed only by destruction, for example, such that once removed, it can no longer be reused.

For example, it is preferable that a skilled or professional operator (or user) break the anti-tampering device before doing anything. In this case, a new anti-tampering device can be placed on and secured to the cap and/or neck of the tank after the operation is finished.

The shell may comprise an upper wall. The shell may comprise a side wall. The first portion may be hinged to the second portion, for example along the side wall.

According to one aspect of the disclosure, the locking means comprises a tab provided on the first portion and tab receiving means provided in the second portion, and the tab is intended to snap into the tab receiving means. The tab receiving means may comprise a receptacle.

According to one aspect of the disclosure, the tab comprises a protruding portion intended to be held by the receiving means after the tab has snapped into the receiving means, for example by engaging the receiving means. The receiving means may comprise a lip, for example, with which the protruding portion of the tab can engage.

In some examples, the locking means can be unlocked. The locking means may be reversible. The device may comprise tamper-evident means, which may be configured to provide evidence of unlocking the locking means.

The locking means may be configured to be unlocked, when in use, by deforming the tab relative to the receiving means. The locking means may be configured to be unlocked, when in use, by inserting a tool, such as a screwdriver, into the receiving means, for example to force the protruding portion to disengage from the receiving means. The locking means may be configured to be unlocked, when in use, by inserting a tool into the receiving means in order to move the protruding portion of the lip away from the receiving means or to prevent any engagement with this lip.

The tamper-evident means may comprise a tamper-proof lid. The tamper-proof lid may prevent access to the receiving means. In some examples, the tamper-proof lid must be dislodged, for example before the tool can be inserted into the receiving means to unlock the locking means.

According to one aspect of the disclosure, the tamper-evident means comprise a label. The label may be intended to be affixed both to the first portion and to the second portion, for example when they form a shell around the cap and/or the neck of the tank.

The first and/or second portion may each comprise a part of the upper wall, for example a semi-circular part. The first and/or second portion may each comprise a part of the side wall, for example a semi-cylindrical part, which may extend downward from the part of the semi-circular upper wall and which may be connected to the latter by a curved part.

The label may be intended to be affixed to the part of the upper wall of both the first and second portions, for example when they form the shell around the cap and/or the neck of the tank.

In other examples, the first or second portion may comprise a circular part of the upper wall or the entire upper wall. The other portion may also comprise the side wall part and/or the curved part.

According to one aspect of the disclosure, the label is configured to provide a visual indication of its removal and/or upon unlocking the locking means, for example when it has been affixed to the first and second portions.

According to one aspect of the disclosure, the label is configured to break or be damaged when it is removed and/or upon unlocking the locking means, for example when it has been affixed to the first and second portions.

The present disclosure also relates to an anti-tampering device for a degassing tank cap of a vehicle cooling circuit, the tank comprising a neck and a cap for sealing the neck, wherein it comprises anti-tampering means that can be used to secure the cap to the neck.

According to one aspect of the disclosure, the anti-tampering means comprise cooperating locking elements on both the cap and the neck.

According to one aspect of the disclosure, the cooperating locking elements comprise a stop on both the cap and the neck.

According to one aspect of the disclosure, at least one of the stops is included on a deformable tab.

According to one aspect of the disclosure, the deformable tab of one of the neck and of the cap is configured to bend, for example when the cap is screwed onto the neck. The deformable tab of one of the neck and of the cap can be configured to bend when the cap is screwed onto the neck until the cap reaches a sealed position, for example at which point the deformable tab snaps into a locked position in which the stops are engaged.

According to one aspect of the disclosure, the deformable tab of one of the neck and of the cap is configured to bend upon engagement with a tool, for example to thereby unlock the anti-tampering means.

The present disclosure also relates to a degassing tank of a vehicle cooling circuit, the tank comprising a neck and a cap for sealing the neck, wherein it comprises a device as described above.

The present disclosure also relates to a degassing tank of a vehicle cooling circuit, the tank comprising a neck and a cap for sealing the neck, wherein it comprises anti-tampering means that can be used to secure the cap to the neck. The present disclosure further relates to a vehicle cooling circuit comprising a degassing tank as described above, as well as to a vehicle comprising such a cooling circuit.

According to one aspect of the disclosure, the cooling circuit is a cooling circuit of at least one battery of the vehicle.

Of course, the disclosure applies to any cooling circuit comprising at least one degassing tank.

According to one aspect of the disclosure, the vehicle is an electric or hybrid vehicle.

Of course, the term “vehicle” refers to any type of vehicle, for example, a car, a motorcycle, a truck, a boat, an airplane, etc.

For the avoidance of doubt, all the features described herein also apply to any aspect of the disclosure.

As part of this application, it is expressly provided that the various aspects, embodiments, examples and alternatives disclosed in the preceding paragraphs, in the claims and/or in the following description and drawings, and in particular the individual features thereof, may be taken separately or in any combination. In other words, all embodiments and/or features of any embodiment may be combined in any way, unless these features are incompatible.

For the avoidance of doubt, the terms “can”, “and/or”, “for example”, and any other similar term used herein must be interpreted as not limiting, such that any feature described herein is not necessarily required to be present. Indeed, any combination of optional features is expressly foreseen without departing from the scope of the disclosure, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 schematically shows an anti-tampering device for a degassing tank cap of a vehicle cooling circuit according to a first embodiment of the present disclosure.

FIG. 2 schematically shows, from a first perspective, the anti-tampering device in FIG. 1 when it is applied to a neck of the degassing tank.

FIG. 3 schematically shows, from a second perspective, the anti-tampering device in FIG. 1 when it is applied to a neck of the degassing tank.

FIG. 4 schematically shows the anti-tampering device in FIG. 1 when it is locked to secure it to the cap and/or to the neck of the degassing tank.

FIG. 5 schematically shows an anti-tampering device for a degassing tank cap of a vehicle cooling circuit according to a second embodiment of the present disclosure.

FIG. 6 schematically shows, from a first perspective, the anti-tampering device in FIG. 5 when it is applied to a neck of the degassing tank.

FIG. 7 schematically shows the anti-tampering device in FIG. 5 when it is locked to secure it to the cap and/or to the neck of the degassing tank.

FIG. 8 schematically shows an anti-tampering device for a degassing tank cap of a vehicle cooling circuit according to a variant of the second embodiment of the present disclosure, locked to secure it to the cap and/or to the neck of the degassing tank.

FIG. 9 schematically shows an enlarged view of the front of the receptacle of the anti-tampering device in FIG. 8, with the tamper-proof lid preventing access to the receptacle.

FIG. 10 schematically shows a view similar to that in FIG. 9, but with the tamper-proof lid dislodged to allow access to the receptacle.

FIG. 11 shows a cross-sectional view of the locking means when they are in the position illustrated in FIG. 10.

FIG. 12 schematically shows a view similar to that in FIG. 8, but with the locking means in an unlocked position and with the anti-tampering device in a partially open position.

FIG. 13 schematically shows an anti-tampering device for a degassing tank cap of a vehicle cooling circuit according to a third embodiment of the present disclosure when it is applied to a neck of the degassing tank.

FIG. 14 schematically shows the anti-tampering device in FIG. 13 when it is locked onto the cap and/or onto the neck of the degassing tank.

FIG. 15 schematically shows the anti-tampering device in FIG. 13 when it is locked onto the cap and/or onto the neck of the degassing tank and with a label affixed to both the first portion and the second portion.

FIG. 16 schematically shows a degassing tank of a vehicle cooling circuit comprising anti-tampering means that can be used to secure the cap to the neck according to one embodiment of the present disclosure.

FIG. 17 schematically shows the underside of the degassing tank cap in FIG. 16.

FIG. 18 schematically shows the neck of the degassing tank in FIG. 16.

FIG. 19 schematically shows the interaction between the cap and the neck of the degassing tank in FIG. 16.

FIG. 20 schematically shows the underside of the cap when mounted on the neck of the degassing tank in FIG. 16.

FIG. 21 schematically shows a degassing tank of a vehicle cooling circuit comprising anti-tampering means that can be used to secure the cap to the neck according to another embodiment of the present disclosure.

FIG. 22 schematically shows the neck of the degassing tank in FIG. 21.

FIG. 23 schematically shows the interaction between the cap and the neck of the degassing tank in FIG. 21.

FIG. 24 schematically shows an alternate neck that can be used in the degassing tank in FIG. 21.

### DETAILED DESCRIPTION

Various aspects of an anti-tampering device for a cooling circuit degassing tank cap according to one aspect of the disclosure are described in more detail below, in reference to the drawings appended hereto.

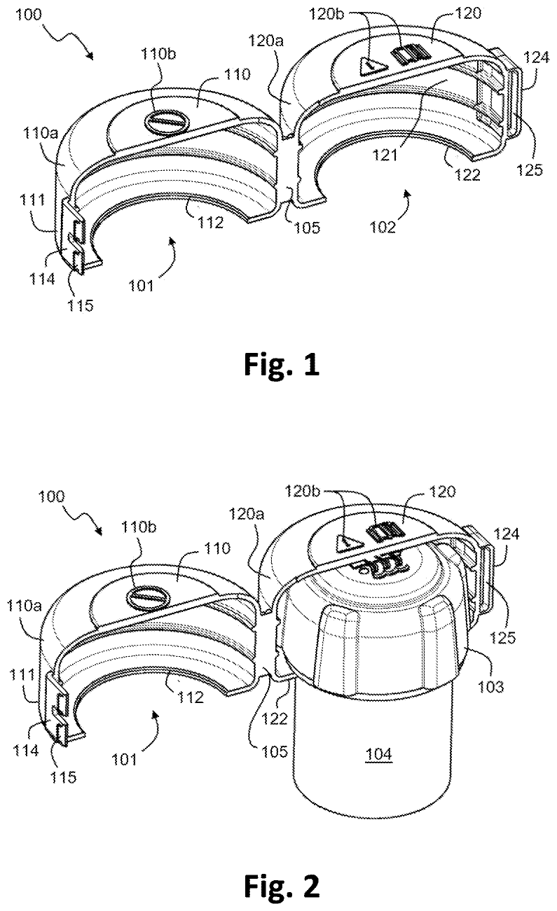

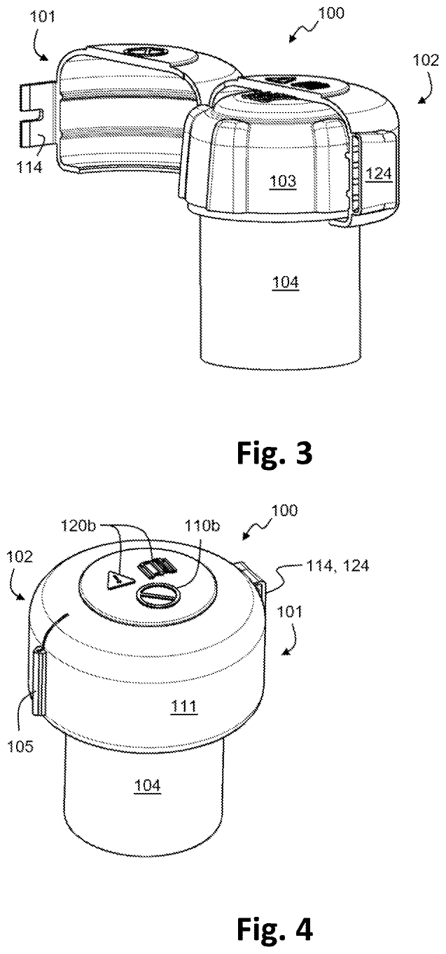

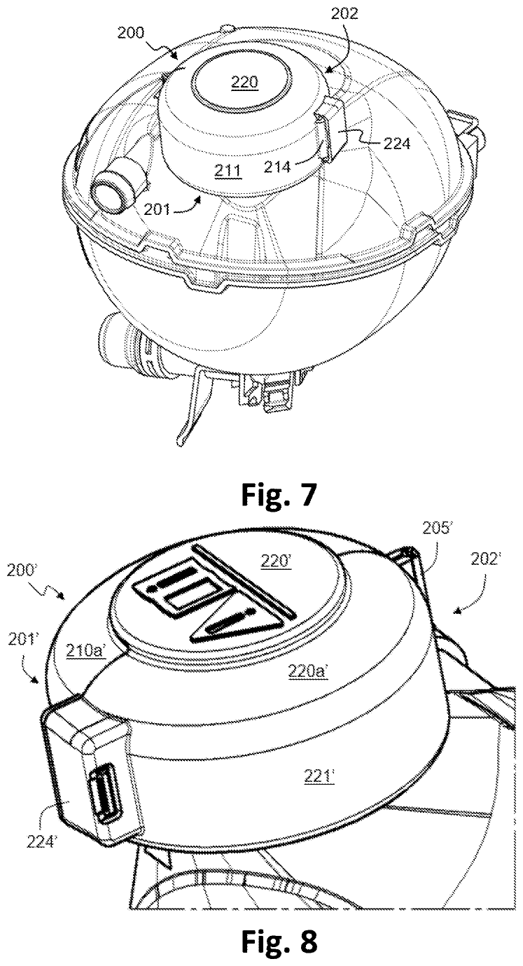

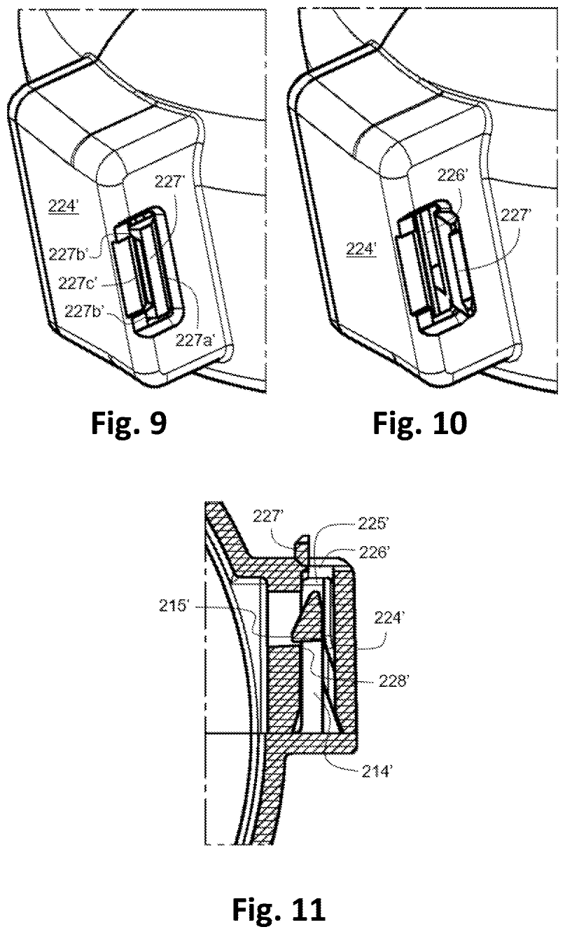

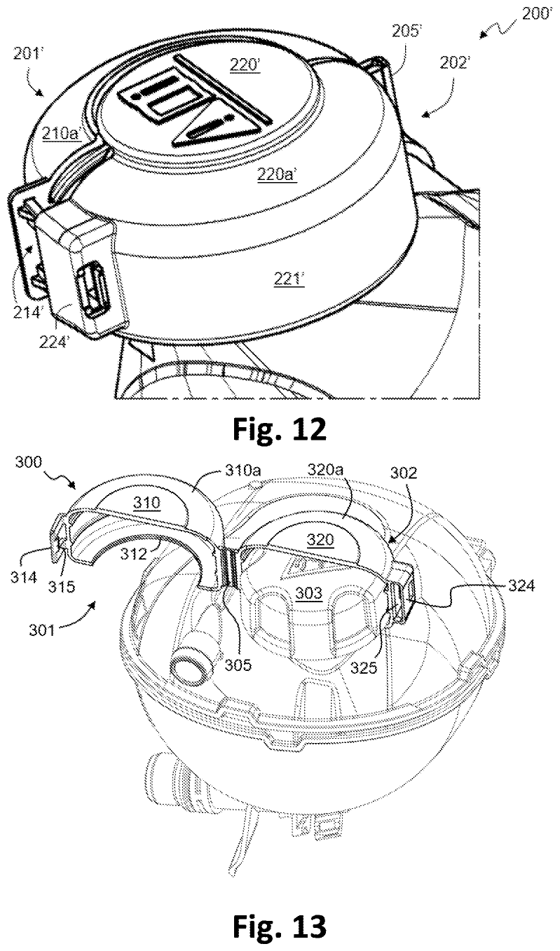

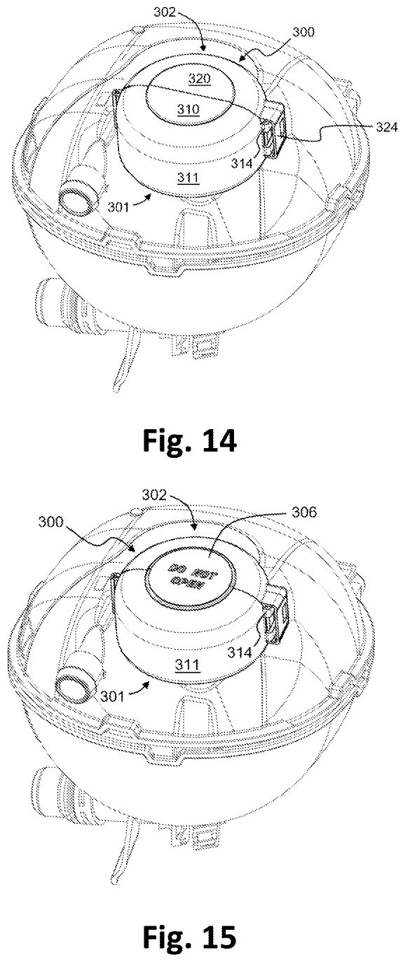

Anti-tampering means for a degassing tank cap of a vehicle cooling circuit are described below in relation to FIGS. 1 through 19.

For example, the cooling circuit is a cooling circuit of at least one battery of the vehicle. For example, the battery is a battery comprising multiple cells. For example, the battery is a lithium or nickel battery. Of course, the cooling circuit may also be adapted to cool other components of the vehicle, for example an electric powertrain.

Thus, a cooling circuit as referred to in the context of the present disclosure may be any cooling circuit, which includes in particular cooling circuit for systems that may include at least one battery. For example, a cooling circuit according to the disclosure may be a cooling circuit of an electric powertrain. For example, the cooling circuit may aim to cool the electric engine(s) and/or the power electronics driving the engines and/or the power electronics of the onboard charger and/or the battery or batteries, as well as other possible components.

For example, since the battery or batteries and the electric powertrain have different operating temperatures and heating/cooling requirements, a cooling circuit according to the disclosure may comprise two cooling sub-circuits which may be separate or coupled depending on the vehicle operating modes.

The cooling circuit or circuits may comprise multiple degassing tanks in the same vehicle.

For example, the vehicle is an electric vehicle. Of course, the vehicle may also be a hybrid vehicle or even any other type of vehicle.

For example, the anti-tampering means may comprise an anti-tampering device that comprises a first portion and a second portion adapted to form a shell around the cap and/or a neck of the tank. The anti-tampering device is thus, for example, a shell comprising the first and second portions.

Referring now to FIGS. 1 through 4, such an anti-tampering device 100 can be seen. The anti-tampering device 100 comprises a first portion 101 and a second portion 102 adapted to form a shell around a cap 103 and a neck 104 of a degassing tank (not shown) on which the cap 103 is installed.

The first portion 101 is substantially semi-cylindrical with a semi-circular upper wall 110 and a semi-cylindrical side wall 111 which extends downward from the semi-circular upper wall 110 and is connected to the latter by a curved part 110a. The first portion 101 also comprises a radial lip 112 protruding inward from the lowest end of the side wall 111.

Likewise, the second portion 102 is also substantially semi-cylindrical with a semi-circular upper wall 120 and a semi-cylindrical side wall 121 which extends downward from the semi-circular upper wall 120 and is connected to the latter by a curved part 120a. The second portion 101 also comprises a radial lip 122 protruding inwardly from the lowest end of the side wall 121.

The upper walls 110, 120 comprise tamper indicators 110b, 120b to deter unskilled persons from removing the anti-tampering device 100 from the cap 103 and from the neck 104.

A first side edge of the semi-cylindrical side wall 111 of the first portion 101 is hinged to a first side edge of the semi-cylindrical side wall 121 of the second portion 102 by a flexible hinge 105 built into or attached to or made in one piece with both the first and second portions 101, 102 in this example.

The anti-tampering device 100 comprises locking means of locking the first portion 101 and second portion 102 around the cap 103 and the neck 104 of the tank. In this example, the second side edge of the semi-cylindrical side wall 111, 121 of both the first and second portions 101, 102 comprises respective locking features.

More specifically, the locking means comprises a tab 114 extending from a second side edge of the semi-cylindrical side wall 111 of the first portion 101 and tab receiving means 124 in the second portion 102. The tab 114 is built into or attached to or made in one piece with the first portion 101 and the tab receiving means 124 are built into or attached to or made in one piece with the second portion 102.

The tab 114 is intended to snap into the tab receiving means 124. The tab 114 comprises a protruding portion 115 intended to be held by the receiving means 124 after the tab 114 has snapped into the receiving means 124. In this example, the protruding portion 115 is a raised strip created on one end of the tab.

In this example, the receiving means 124 comprise a channel portion (or a receptacle or pierced housing) 125 arranged in the second portion 102 in which the tab 114 is introduced when locking. The length of the channel portion 125 is such that once the tab 114 is fully inserted, the projecting protruding portion 115 exits the channel and is held by a blank flange (not shown) of the channel portion 125.

The tab 114 and the receiving means 124, in particular the protruding portion 115, are, for example, designed to snap together irreversibly. In other words, the tab 114 and the receiving means 124 are configured to prevent non-destructive disengagement of the tab 114 and the receiving means 124. The tab 114 therefore cannot be dislodged from the protruding portion 115. Destruction of the locking means is thus necessary to access the cap 103. The channel portion 125 may also be shaped so as not to allow access to the tab 114 and to the protruding portion 115 using a tool, such as a screwdriver.

In addition or as a variant, the flexible hinge 105 may comprise or describe a line of weakness along which the connection between the first and second portions 101, 102 can be broken.

As a variant, a tool, such as a screwdriver (not shown), may be inserted into the channel portion 125 when the tab 114 is locked therein, with its protruding portion 115 engaged with the blank flange (not shown). The tool can then be manipulated to bend the tab 114 and to dislodge the protruding portion 115 from its engagement with the blank flange (not shown) to release the tab 114 from the channel portion 125. In addition or alternatively, the channel portion 125 may comprise a notch, which allows the tool to be inserted into the channel portion 125 when the tab 114 is locked therein.

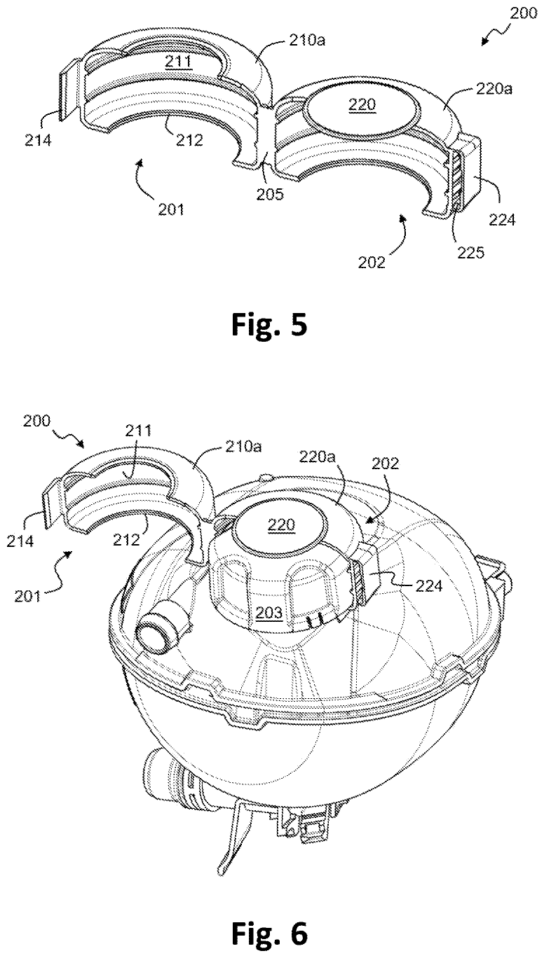

FIGS. 5 through 7 show an anti-tampering device 200 according to a second example, similar to the anti-tampering device 100 according to the first example, wherein the similar characteristics are identified by the same references, incremented by 100. These characteristics will not be described.

The anti-tampering device 200 according to this example differs from the previous example in that the upper wall 220 of the second portion 202 is circular, while the upper wall 110 included in the previous example is omitted from the first portion 201 in this example. Therefore, when the device 200 is in the closed position, the upper wall 220 is uninterrupted.

FIGS. 8 through 12 show an anti-tampering device 200′ according to a variant of the second example, wherein the similar characteristics are identified by the same references, with the addition of an ‘. These characteristics will not be described.

The anti-tampering device 200’ according to this example differs from the previous example in that it comprises tamper-evident means configured to provide evidence of unlocking the locking means 214′, 224′. In this example, an access hole 226′ is provided on a front face of the device 200′, opposite the side in which the tab 214′ is inserted into the receptacle/channel part 225′, and the tamper-evident means are in the form of a tamper-proof lid 227′, which prevents access to the hole 226′.

The tamper-proof lid 227′ comprises a living hinge 227a′ on a first of its sides, around which it can pivot, and a pair of frangible connectors 227b′ securing it in a position in which it covers the access hole 226′. The tamper-proof lid 227′ can be dislodged by inserting a tool (not shown) into a slot 227c′ between the frangible connectors 227b′ and pivoting it around the living hinge 227a′. This allows access to the access hole 226′, which allows the tool (not shown) to be inserted therein and manipulated to bend the tab 214′ to dislodge the protruding part 215′ from its engagement with the blank flange 228′ to release the tab 214′ from the channel part 225′.

Referring now to FIGS. 13 through 15, an anti-tampering device 300 according to a third example has been shown, which is similar to the anti-tampering device 100 according to the first example, wherein similar characteristics are identified by the same references, incremented by 200. These characteristics will not be described.

The anti-tampering device 300 in this example differs from the first example in that the tamper indicators 110b, 120b are omitted, providing a smooth surface on which a label 306 is placed when the first and second portions 301, 302 are locked together. The label 306 in this example is configured to provide a visual indication of its removal and/or upon unlocking the locking means. Such visual indication may be provided by one of the many means known in the art, such as damage, delamination, destruction, color change or any other appropriate visual indicator.

It is also possible, according to other embodiments according to the disclosure, to build this anti-tampering device directly into the cap/tank assembly, by making changes to these components. For example, this can be done without adding additional components.

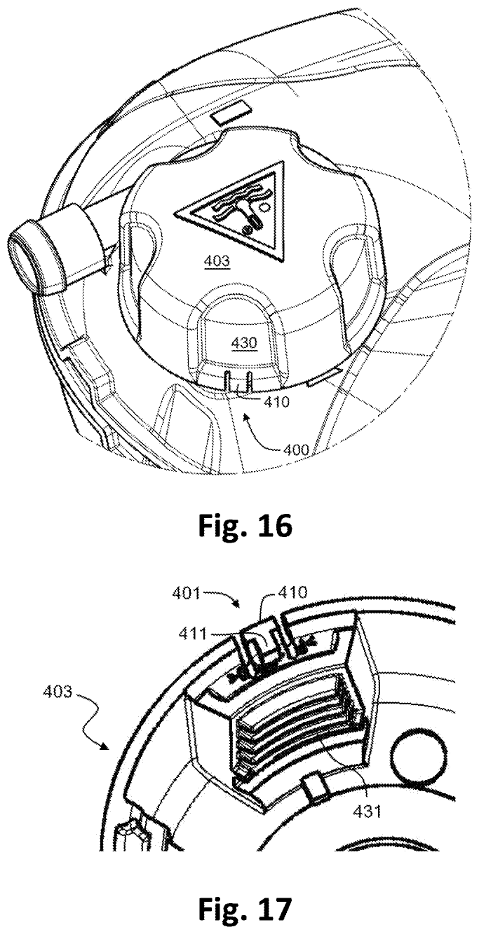

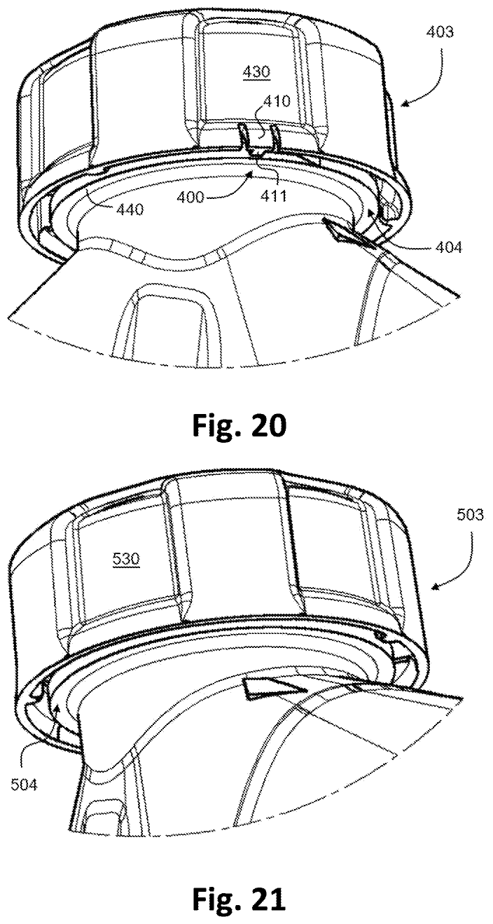

Referring now to FIGS. 16 through 20, such an anti-tampering device 400 can be seen. The anti-tampering device 400 according to this example comprises anti-tampering means embedded in the cap 403 and the neck 404. More specifically, the anti-tampering device 400 comprises cooperating locking elements 401, 402 on both the cap 403 and the neck 404.

A first locking member 401, shown more clearly in FIG. 17, is embedded in the cap 403 and comprises a deformable tab 410 described in a lower part of the side wall 430 of the cap 403. The deformable tab 410 is built into or attached to or made in one piece with the cap 403 and comprises a radial stop 411 protruding inwardly from its free end.

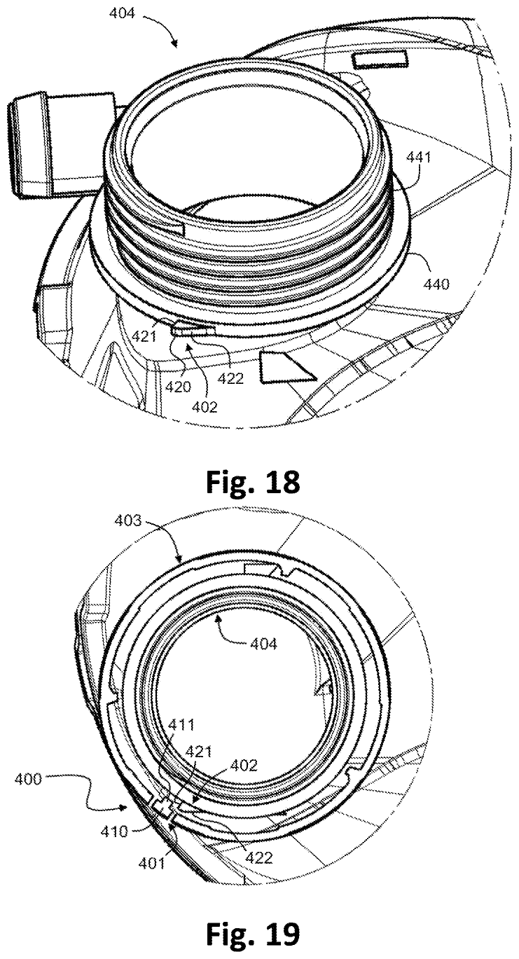

A second locking member 402, shown more clearly in FIG. 18, is embedded in the neck 404 and comprises a radial stop 420 with a radial stop surface 421 and a tapered side 422 on the opposite circumferential side of the radial stop 420. The radial stop 420 is built into or attached to or made in one piece with the neck 404 and protrudes from a flange 440 under the screw threads 441 on the neck 404 that engage the cooperating screw threads 431 on the inner side of the side wall 430 of the cap 403.

The anti-tampering device 400 is thus configured such that when the cap 403 is screwed onto the neck 404 to a final, sealed position, the radial stop 411 of the first locking member 401 mounts on the tapered side 422 of the radial stop 420 of the second locking member 402. The deformable tab 410 bends to allow the radial stop 411 to move radially outward. The continuous rotation causes the radial stop 411 to protrude past the radial stop 420 of the second locking member 402, until it snaps into alignment with the radial stop face 421.

In this position, illustrated in FIG. 19, the radial stops 411, 421 prevent the cap 403 from becoming unscrewed from the neck 404. To remove the cap 403 from the neck 404, a tool, such as a screwdriver (not shown), must be inserted between the radial stop 411 of the first locking member 401 and the flange 440 of the neck 404. The tool must then be manipulated to deflect the deformable tab 410 outward when a loosening torque is applied to the cap 403. Once the deformable tab 410 is deflected such that the stops 411, 421 are no longer radially aligned, the cap 403 can then be unscrewed and removed from the neck 404.

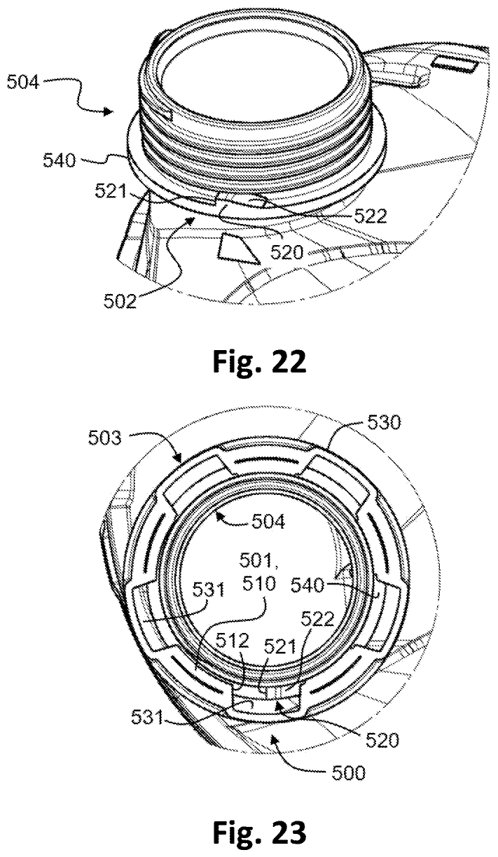

FIGS. 21 through 23 show another example of an anti-tampering device 500, similar to the previous example of an anti-tampering device 400, wherein similar characteristics are identified by the same references, incremented by 100. These characteristics will not be described.

The anti-tampering device 500 according to the present example differs from that of the previous example in that the radial stops 411, 421 are replaced by axial stops 510, 520. More specifically, the side wall 530 of the cap 503 comprises a series of axial recesses 531 on its inner surface each describing a stop surface 511, and the lip 540 of the neck 504 comprises an axial stop 520 with a stop surface 521 and a tapered side 522 on the opposite circumferential side of the axial stop 520.

When the cap 503 is screwed onto the neck 504 to a final and sealed position, the side wall 530 of the cap 503 deforms slightly when it mounts on the tapered side 522 of the axial stop 520 of the second locking member 502. Further rotation causes one of the axial recesses 531 to align with the axial stop 520 of the second locking member 502, so that the stop faces 511, 521 are aligned and prevent reverse rotation, as illustrated in FIG. 23.

As in the previous example, a tool can be inserted between the cap 503 and the neck 504 when a loosening torque is applied to the cap 503, thereby allowing the cap 503 to be removed from the neck 504.

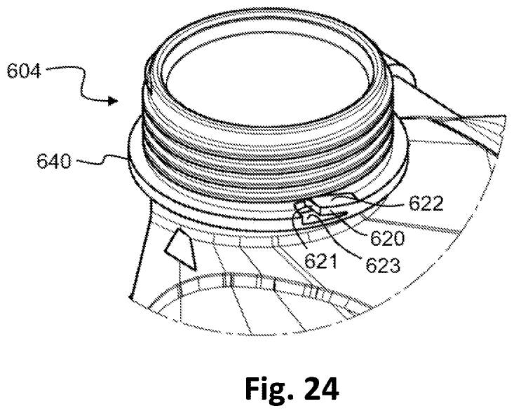

FIG. 24 shows another example of a neck 604 that can be used with the same cap 503 as in the previous example. In this example, a deformable tab 620 constitutes the axial stop, which can be deflected into an axial recess 623 of the flange 640 of the neck 604. The deformable tab 620 can thus be deflected by the side wall 530 of the cap 503 until it aligns with one of the axial recesses 531, when it snaps into the axial recess 531.

Alternatively, of course, the channel portion may also comprise a recess sized and shaped to conform to the projecting portion of the tab as it snaps in.

Throughout the description and claims, the words “comprise” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification should be understood to include the plural as well as the singular, unless the context requires otherwise.

Any features, integers, characteristics, compounds or groups described in connection with a particular aspect, embodiment or example of the disclosure are to be understood as being applicable to any other aspect, embodiment or example described herein, unless inconsistent therewith.

The reader's attention is drawn to all papers and documents that are filed concurrently or prior to this specification in connection with this application and that are open for public inspection with this specification, and the content of all such papers and documents is incorporated herein by reference.

List of Reference Signs

| | |
|---|---|
| 100 | anti-tampering device |
| 101 | first portion |
| 110 | semi-circular upper wall |
| 111 | semi-cylindrical side wall |
| 110a | curved part |
| 110b | tamper indicators |
| 112 | radial lip |
| 114 | locking tab |
| 115 | protruding portion |
| 102 | second portion |
| 120 | semi-circular upper wall |
| 120a | curved part 120a |
| 120b | tamper indicators |
| 121 | semi-cylindrical side wall |
| 122 | radial lip |
| 124 | tab receiving means |
| 125 | channel portion |
| 103 | cap |
| 104 | degassing tank neck |
| 105 | flexible hinge |
| 200 | anti-tampering device |
| 201 | first portion |
| 211 | semi-cylindrical side wall |
| 210a | curved part |
| 212 | radial lip |
| 214 | locking tab |
| 202 | second portion |
| 220 | circular upper wall |
| 220a | curved part 120a |
| 221 | semi-cylindrical side wall |
| 222 | radial lip |
| 224 | tab receiving means |
| 225 | channel portion |
| 203 | cap |
| 204 | degassing tank neck |
| 205 | flexible hinge |
| 200' | anti-tampering device |
| 201' | first portion |
| 210a' | curved part |
| 214' | locking tab |
| 202' | second portion |
| 220' | circular upper wall |
| 220a' | curved part 120a |
| 221' | semi-cylindrical side wall |
| 224' | tab receiving means |
| 225' | channel part |
| 226' | access hole |
| 227a' | living hinge |
| 227b' | frangible connectors |
| 227c' | slot |
| 228' | blank flange |
| 205' | flexible hinge |
| 300 | anti-tampering device |
| 301 | first portion |
| 310 | semi-circular upper wall |
| 311 | semi-cylindrical side wall |
| 310a | curved part |
| 312 | radial lip |
| 314 | locking tab |
| 315 | protruding portion |
| 302 | second portion |
| 320 | semi-circular upper wall |
| 320a | curved part 120a |
| 321 | semi-cylindrical side wall |
| 322 | radial lip |
| 324 | tab receiving means |
| 325 | channel portion |
| 303 | cap |
| 304 | degassing tank neck |
| 305 | flexible hinge |
| 306 | label |
| 400 | anti-tampering device |
| 401 | first locking member |
| 410 | deformable tab |
| 411 | radial stop |
| 402 | second locking member |
| 420 | radial stop |
| 421 | radial stop surface |
| 422 | tapered side |
| 403 | cap |
| 430 | side wall |
| 431 | cap screw threads |
| 404 | neck |
| 440 | flange |
| 441 | neck screw threads |
| 500 | anti-tampering device |
| 501 | first locking member |
| 510 | axial stop |
| 511 | stop surface |
| 502 | second locking member |
| 520 | axial stop |
| 521 | stop surface |
| 522 | tapered side |
| 503 | cap |
| 530 | side wall |
| 504 | neck |
| 540 | flange |
| 620 | deformable tab |
| 623 | axial flange recess |
| 604 | neck |
| 640 | flange |

What is claimed is:

1. An anti-tampering device (100, 200, 300, 400, 500) for securing a cap (103, 203, 303, 403, 503) onto a neck of a degassing tank of a vehicle cooling circuit, wherein the device comprises locking means that are attached to a shell configured to surround and secure the cap on the neck (104, 204, 304).

2. The anti-tampering device for a tank cap according to claim 1, wherein the shell comprises a first portion (101, 201, 301) and a second portion (102, 202, 302) each comprising cooperating parts of the locking means.

3. The anti-tampering device for a tank cap according to claim 2, wherein the shell comprises an upper wall and a side wall and that the first portion is hinged to the second portion along the side wall.

4. The anti-tampering device for a tank cap according to claim 2, wherein the locking means comprises a tab (114, 214, 314) provided on the first portion and tab receiving means (124, 224, 324) provided in the second portion, and in that the tab is intended to snap into the tab receiving means.

5. The anti-tampering device for a tank cap according to claim 4, wherein the tab comprises a protruding portion (115, 315) intended to be held by the receiving means after the tab has snapped into the receiving means.

6. The anti-tampering device for a tank cap according to claim 1, wherein the locking means are non-unlockable.

7. The anti-tampering device for a tank cap according to claim 6, wherein it is configured to be removed only by destruction.

8. The anti-tampering device for a tank cap according to claim 4, wherein the locking means are configured to be unlocked, when in use, by deforming the tab relative to the receiving means or the locking means are configured to be unlocked, when in use, by inserting a tool into the receiving means to force the protruding portion to disengage from the receiving means.

9. The anti-tampering device for a tank cap according to claim 8, wherein it comprises tamper-evident means that are configured to provide evidence of unlocking the locking means.

10. The anti-tampering device for a tank cap according to claim 9, wherein it is configured to be removed only by destroying the tamper-evident means.

11. The anti-tampering device for a tank cap according to claim 9, wherein the tamper-evident means comprise a tamper-proof lid preventing access to the receiving means, which must be dislodged before the tool can be inserted into the receiving means to unlock the locking means.

12. The anti-tampering device for a tank cap according to claim 9, wherein the tamper-evident means comprise a label (306) intended to be affixed to both the first portion and the second portion when they form a shell around the cap or the neck of the tank, the label being further configured to break or be damaged when it is removed or upon unlocking the locking means, when it has been affixed to the first and second portions.
